(19) United States
(12) Patent Application Publication
(10) Pub. No.: US 2015/0356570 A1
(43) Pub. Date: Dec. 10, 2015

(54) PREDICTING INTERACTIONS OF SOCIAL NETWORKING SYSTEM USERS WITH APPLICATIONS

(71) Applicant: Facebook, Inc., Menlo Park, CA (US)

(72) Inventors: Aaron Payne Goldsmid, San Francisco, CA (US); George Lee, Mountain View, CA (US); Vishu Gupta, Atherton, CA (US); Daniel Richard Morris, San Francisco, CA (US); David Joseph Engelberg, San Francisco, CA (US); Brendan Marten, Menlo Park, CA (US); Tina Marie Cardaci, San Francisco, CA (US); Niket Biswas, San Francisco, CA (US)

(73) Assignee: Facebook, Inc., Menlo Park, CA (US)

(21) Appl. No.: 14/297,053

(22) Filed: Jun. 5, 2014

(51) Int. Cl. G06Q 30/02; G06Q 50/00

(52) U.S. Cl. CPC G06Q 30/0201; G06Q 30/0269; G06Q 30/0249; G06Q 50/01

(57) ABSTRACT

A social networking system provides instructions to third-party application developers for inclusion in applications. When executed, the instructions communicate information from an application to the social networking system describing user interactions with the application. Based on received information describing a user's interaction with an application, the social networking system determines likelihoods of the user performing various types interactions with applications and classifies the user based on the determined likelihoods. A user's interactions with additional applications similar to an application may be used to determine the likelihoods of the user performing different types of interactions with the application. Classifications associated with users may be used as targeting criteria for advertisements, allowing advertisers to target advertisements to users having a threshold likelihood of performing certain types of interactions with an application.

### BACKGROUND

This disclosure relates generally to social networking systems, and more specifically to predicting interactions of users of a social networking system with applications.

Application developers generate revenue from the sale and distribution of applications (e.g., applications for games, tools, etc.) as well as from various types of user engagement with applications. Commonly, application developers charge users for purchases made through applications provided by the application developers. For example, users of a game application make purchases in an application for access to various features of the application or for virtual commodities used by the application. Additionally, application developers may earn revenue from advertisers by charging advertisers for advertisements presented to users via an application (e.g., for each advertisement impression through the application, for each user interaction with an advertisement through the application, etc.).

However, different users may perform different types of interactions with different types of applications. For example, some users of a game application make an average of $10 in purchases per week in the application while other users of the game same game application do not typical make purchases in the application but spend at least 8 hours per week interacting with the application. In the previous example, a developer of the game application would increase earned revenue by presenting the users making purchase in the game application with promotions for products to be purchased in the application while presenting the users frequently interacting with the application with advertisements for products or services. However, while application developers may have the ability to track user activity in their applications, they often lack time or resources to analyze user activity to identify various users' application usage patterns or the ability to track user activity other applications. Additionally, advertisers conventionally do not have access to information about user activity in a third-party applications for identifying applications to present to users via applications or for determining budgets for presenting advertisements to a user via an application.

### SUMMARY

To allow more accurate targeting of content for presentation via an application, a social networking system associates one or more classifications with a social networking system user based on the likelihoods of the user performing various types of interactions with the application. To determine the likelihoods of the user performing types of interactions, the social networking system retrieves information describing prior interactions by the user with one or more applications. For example, the social networking system provides a software development kit (“SDK”) to third-party application developers including instructions for inclusion in one or more applications. When the instructions are executed, an application communicates information describing interactions with the application, identifying the application, and identifying a social networking system user performing the application. For example, an application communicates to the social networking system information identifying types of products a user purchased in the application, times of day the user interacted with the application, and a number of social interactions with other users performed by the application.

In various embodiments, the social networking system applies one or more machine-learned models to information describing prior interactions by a user with one or more applications to determine the likelihoods of the user performing different types of interactions with an application. For example, different machine-learned models are associated with different types of interactions and applied to prior interactions between the user and one or more applications to determine likelihoods of the user performing different types of interactions with one or more applications. Prior interactions between the user and additional applications with a threshold measure of similarity to an application may be used to determine the user's likelihoods of performing different types of interactions with the application. Based on the determined likelihoods of the user performing various types of interactions, the social networking system associates one or more classifications with the user. The classifications may be expressed as minimum or maximum values (e.g., a minimum or maximum amount of money a user is likely to spend in an application), as an expected probability of a type of interaction, or as a range of values (e.g., a range of minutes a user is likely to interact with an application, a number of times a user is presented with an advertisement via an application before performing an action associated with the advertisement and a margin of error associated with the estimate, etc.).

Classifications associated with a user based on the user's likelihoods of performing types of interactions with an application may be used to select content for presentation to the user. For example, classifications associated with a user are compared to targeting criteria associated with advertisements to identify advertisements eligible for presentation to the user. As an example, users associated with a classification of at least a threshold likelihood of making purchases in an application are identified as eligible to receive advertisements associated with targeting criteria specifying the threshold likelihood of making purchase in an application. The classifications may also be used to target users to receive promotions for purchase or actions performed via an application based on the user's likelihoods of performing different types of interactions with the application. For example, users associated with a classification of less than a threshold likelihood of making purchases in an application but associated with a classification of spending at least a threshold amount of time interacting with the application are identified as eligible to receive advertisements associated with targeting criteria specifying the threshold amount of time interacting with the application.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for classifying social networking system users based on historical user interactions with applications, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

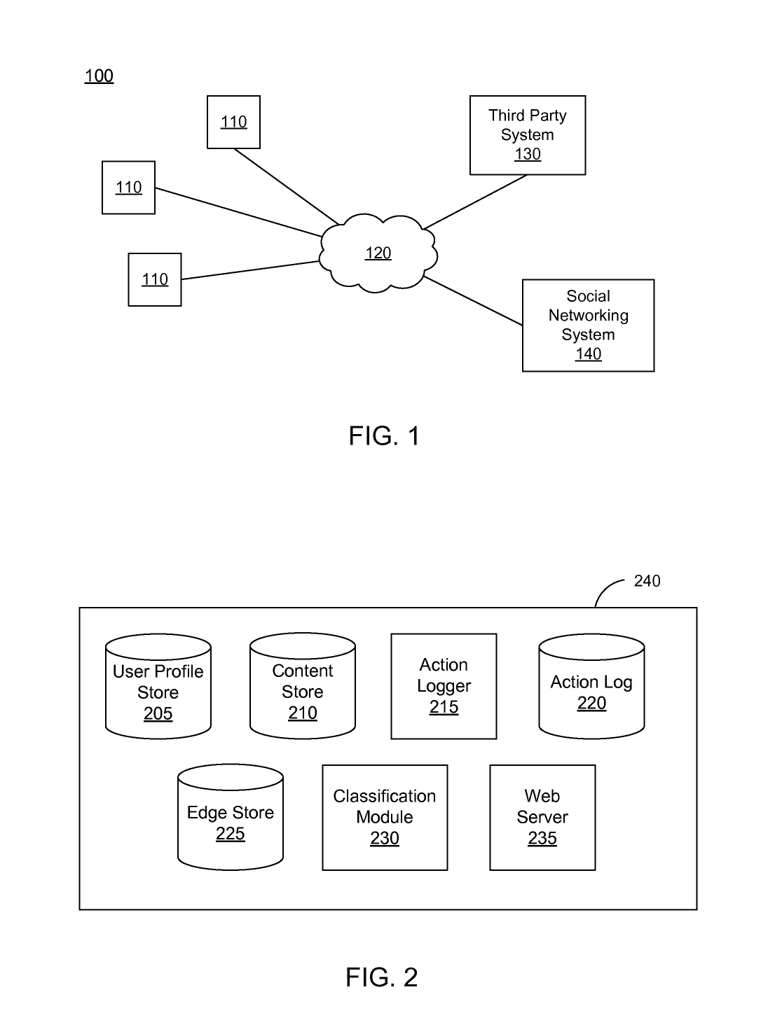

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™. Additionally, a client device 110 may execute various applications through the API executing on the native operating of the client device 110.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140, which may be an online system in some embodiments. The social networking system 140 shown in FIG. 2 includes a user profile store 205, a content store 210, an action logger 215, an action log 220, an edge store 225, a classification module 230, and a web server 235. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

Information associating user interactions with applications may be stored in the user profile store 205. For example, if a social networking system user installs an application, references to the user's interaction and the application are stored in association with the user's profile information. Additionally, a user identifier used to identify a user of the social networking system when the user accesses an application via the social networking system 140 may also be stored in association with the user's profile information. For example, if a user uses the social networking system 140 to access an application, a user identifier is communicated to the social networking system 140 by the application, which the social networking system 140 may use to retrieve information about the user from a user profile for the user.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The classification module 230 likelihoods of a user performing one or more types of interactions with applications based on data describing prior interactions by the user or additional users with applications. Instructions included in one or more additional applications communicate information describing a user's interactions with the additional applications when executed by an application. For example, the social networking system 140 provides a software development kit (SDK) to third-party developers, which include the SDK in applications to communicate information describing user interactions with the applications. To predict a likelihood of a user performing a type of interaction with an application, the classification module 230 may apply a machine-learned model to received information describing a user's interactions with other applications (or to received information describing the user's prior interactions with the application). For example, the classification module 230 applies one or more machine-learned models to information describing a user's interaction with other applications to determine likelihoods of the user making a purchase in an application or interacting with an advertisement presented in the application. Additionally, in some embodiments, the application may be a game and/or have game-like features, and the received information also describes in-game application states. An in-game application state describes the user's relationship with various game features. Examples of an in-game application state include: a game level associated with the user, achievements in the game associated with the user, user scores, another game feature associated with the user, or some combination thereof.

In one embodiment, the classification module 230 determines a user's likelihoods of performing various interactions with an application based in part on interactions with additional applications performed by social networking system users having at least a threshold measure of similarity to the user. For example, the social networking system 140 stores information associating an application with social networking system users in the user profile store 205 and information describing users' interactions with the application in the action log 220. The classification module 230 identifies additional users having at least a threshold number or percentage of characteristics (e.g., age, gender, and geographic region) matching characteristics of a user and determines the user's likelihoods of performing different types of interactions with an application based on interactions by the identified additional users with the application.

The classification module 230 may identify the additional users as users who have installed similar applications to those installed by the user. For example, the classification module 230 identifies an additional user having installed on a client device 110 one or more applications having application characteristics matching at least a threshold number of or percentage of application characteristics associated with applications installed by the user on an associated client device 110. An application characteristic is a characteristic of an application, with examples of application characteristics include a name of the application developer, a function of the application (e.g., electronic book reader, media player, etc.), a category of the application (e.g., finance, entertainment, gaming, educational, etc.), or any other suitable information.

In some embodiments, interactions by additional users with an application are identified and used to determine likelihoods of the user performing various types of interactions with the application if less than a threshold amount of interaction with the application is associated with the user (e.g., if the user recently installed the application or has infrequently interacted with the application). Similarly, a user's interactions with additional applications having at least a threshold similarity to an application may also be used when determining likelihoods of the user performing different types of interactions with the application. For example, a user's likelihood of making a purchase via an application is determined based on prior purchases made by the user via additional applications of the same genre as the application and that are targeted to users having characteristics of the user (e.g., targeted to users of the same gender, age, geographic location, etc. as the user).

If interactions with an application by additional users are used to determine a user's likelihoods of performing types of interactions with the application, weights may be associated with interactions by different additional users based on a measure of similarity between the user and additional users (e.g., a percentage of characteristics of the user matching characteristics of an additional user). Similarly, if interactions by the user with additional applications are used when determining likelihoods of the user performing different types of interactions with an application, a measure of similarity between the application and an additional application may be used to weight interactions with the additional application (e.g., a percentage of characteristics of the additional application matching characteristics of the application). Associating different weights with interactions associated with different additional users or with interactions associated with different applications allows the classification module 230 to more accurately determine a user's likelihoods of performing different types of interactions with an application.

A user's likelihood of performing a type of interaction with an application may be expressed in in a variety of ways. For example, a user's likelihood of performing a type of interaction is expressed as a minimum or maximum value (e.g., a minimum or maximum amount of time a user is likely to spend in an application). In another example, a user's likelihood of performing a type of interaction with an application is expressed as an expected probability of the type of interaction occurring (e.g., a likelihood a user will install an application expressed as a percentage or as a fraction). As another example, a user's likelihood of performing a type of interaction with an application is expressed as a range of values (e.g., a range of monetary amounts a user is likely to spend in an application in a month, a number of times a user is likely to click on advertisements presented in an application and a margin of error associated with the estimate, etc.).

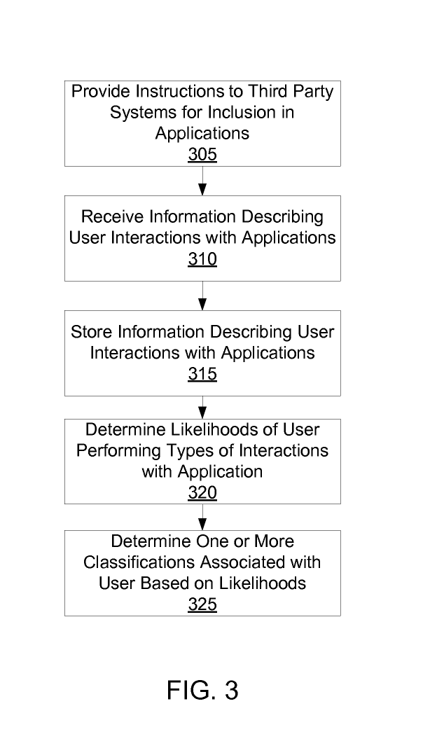

The classification module 230 associates one or more classifications with a user based on the user's predicted likelihoods of performing various types of interactions with an application, as further described below in conjunction with FIG. 3. For example, a classification associated with a user is based on an amount of money the user is likely to spend in the application during a time interval. For example, a user is classified as being likely to spend less than $0.50, between $0.50 and $2.00, between $2.00 and $5.00, or over $5.00 in an application during a time interval. Multiple classifications may be associated with a user corresponding to the user's likelihoods of performing different types of interactions with an application. For example, a user is associated with classifications including: at least a threshold likelihood of spending less than $0.50 per week in an application, at least a threshold likelihood of spending at least 5 hours per week using the application, at least a threshold likelihood of accessing at least 2 advertisements presented in the application per week, and at least a threshold likelihood of using the application at least 5 times per day.

The web server 235 links the social networking system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the social networking system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that is stored in the content store 210. Additionally, the web server 235 may provide application programming interface (API) functionality to send data directly to native client device operating systems, such as IOS®, ANDROID™, WEBOS® or BlackberryOS.

Classifying Social Networking System Users Based on Historical User Interactions with Applications

FIG. 3 is a flow chart of one embodiment of a method for classifying social networking system users based on historical user interactions with applications. In various embodiments, the method may include different and/or additional steps, or fewer steps, than those depicted in FIG. 3. The social networking system 140 provides 305 instructions to one or more third-party systems 130, such as application developers, for communicating information describing user interactions with an application to the social networking system 140. A third-party system 130 includes the instructions in an application, and when the instructions are executed by the application, information identifying the application, identifying a user interacting with the application, and describing the user's interactions with the application is communicated from the application to the social networking system 140. For example, the social networking system 140 provides 305 a software development kit (SDK), which includes instructions that communicate information describing user interactions with an application to a third-party system 130 when the instructions are executed.

The social networking system 140 receives 310 information from one or more applications that describe user interactions with applications when various applications execute the instructions. The received information includes information identifying an application. Examples of information identifying an application include: an identifier associated with the application, a title of the application, a genre associated with the application, a third party system 130 (e.g., a developer of the application), etc. The received information also includes information identifying a user of the social networking system interacting with an application. For example, an age, a gender, and a geographic location of the user are retrieved from information associated with the user by the application (e.g., retrieved from a profile maintained by the application for the user). If the user uses the social networking system 140 to access the application, the information from the application includes a user identifier, which the social networking system 140 uses to retrieve information from a user profile for the user maintained by the social networking system 140.

The received information describing user interactions with applications also includes information describing a user's interactions with an application. Examples of information describing user interaction with an application include: a time a user opened or closed the application, a length of time the user accessed the application, a number of times the application crashed, information describing purchase made by the user via the application. If the application is a game, in-game application states (e.g., a game level associated with the user, achievements in the game associated with the user, user scores, etc.) may be included in the information describing user interaction with the application. For example, purchases made via the application are described using a time the user made a purchase via the application, an amount of the user's purchase via the application, a type of product the user purchased via the application, or other suitable information. The received information describing user interaction with an application may also include information associated with advertisements presented to a user via the application. For example, the social networking system 140 may receive 310 information indicating: a time when a user was presented with an advertisement via an application, a number of times the user was presented with advertisements via the application, a number of times the user interacted with advertisements presented via the application, a number of purchases the user made by interacting with advertisements presented via application, and a number of applications the user installed because of interactions with advertisements presented via the application. Received information describing user interaction with an application may also include information associated with social activity in an application (e.g., a number of additional users a user invited to use an application, a number of messages sent by the user to additional users via the application, a number of connections formed between the user and additional users via the application, etc.). Information about a user's interactions with an application, information identifying the user that performed the interactions, and information about connections formed between users via the application may be stored 315 in the action log 220, in the user profile store 205, and in the edge store 225, respectively.

Based on the received information describing user interaction with one or more advertisements, the social networking system 140 determines 320 likelihoods that the user will perform different types of interactions with one or more applications. The social networking system 140 determines 320 a likelihood of the user performing various types of interactions with an application based on prior interactions the user performed with the application or with additional applications. For example, the social networking system 140 determines 320 the likelihood that a user will install a new shopping application based on the user's prior installations of other shopping applications. A machine-learned model may be used to determine 320 a user's expected likelihoods of performing various interactions with an application based on the user's prior interactions with the application or based on the user's prior interactions with additional applications having a threshold measure of similarity to the application. Different machine-learned models may be used to determine 320 likelihoods of the user performing different types of interactions.

In one embodiment, prior interactions with one or more applications by additional users having at least a threshold similarity to the user are used to determine 320 the likelihoods of the user performing one or more interactions with an application. For example, prior interactions with one or more applications by additional users having at least a threshold number or percentage of characteristics (e.g., age, gender, geographic region) matching characteristics of a user are retrieved and used to determine 320 likelihoods of the user performing various types of interactions with an application. Interactions with one or more applications by additional users may be retrieved and used to determine 320 likelihoods of a user performing different types of interactions with an application if less than a threshold amount of information describing interactions with the application is associated with the user. Interactions with an application by an additional user may be weighted based on a measure of similarity between the additional user and the user. The measure of similarity may be based on a percentage of characteristics of the additional user matching characteristics of the user. In some embodiments, additional users are identified based in part on a similarity between applications installed by the user on an associated client device 110 and applications installed on other client devices 110 associated with additional users. For example, additional users are identified as user having installed on associated client devices 110 applications having at least a threshold number or percentage of application characteristics (e.g., a name of the application developer, a function of the application, a category of the application) matching application characteristics of applications installed by the user on one or more associated client devices 110.

Likelihoods of the user performing one or more interactions with an application may also be determined 320 based on prior interactions by the user with additional applications having at least a threshold measure of similarity to the application. For example, prior interactions by the user with one or more additional applications having at least a threshold number or percentage of characteristics (e.g., genre, target audience) matching characteristics of an application are retrieved and used to determine 320 likelihoods of the user performing various types of interactions with the application. Interactions by the user with one or more additional applications may be retrieved and used to determine 320 likelihoods of the user performing various types of interactions with an application if less than a threshold amount of information describing one or more types of interactions by the user with the application is maintained by the social networking system 140. Interactions with an additional application by the user may be weighted based on a measure of similarity between the additional application and the application. The measure of similarity may be based on a percentage of characteristics of the additional application matching characteristics of the application.

The user's likelihood of performing a type of interaction with an application may be expressed as a minimum, maximum, percentage, or range. For example, the social networking system 140 determines 320 that a user is likely to spend a minimum of $1 and a maximum of $5 in a shooting game application per month. As an additional example, the social networking system 140 determines 320 that there is between a 15% and 20% chance a user will install a price scanner application if the user is presented with an advertisement for the application via another application.

Based on one or more of the classifications associated with a user, the social networking system 140 determines 325 one or more classifications associated with the user. Different classifications correspond to different types of interactions with an application, and the social networking system 140 associates a classification with a user based on the likelihood of the user performing a type of interaction associated with the classification. For example, different classifications are associated with a user based on an expected amount of money the user is likely to spend via an application, an expected frequency of interaction with the application by the user, and an amount of time the user is likely to spend interacting with the application. For example, the social networking system 140 classifies users as being likely to spend less than $0.50 via an application, between $0.50 and $2.00 via the application, between $2.00 and $5.00 via the application, or more than $5.00 via the application. If a user is determined 320 to be likely to spend $2.50 via the application with a $0.50 margin of error, the user is associated with a classification of being likely to spend between $2.00 and $5.00 via the application. Multiple classifications may be associated with a user based on likelihoods of the user performing different types of interactions. For example, a user is associated with classifications including: a likelihood of spending $0.50 to $1.00 per day in an application, a likelihood of inviting at least 5 friends per year to use the application, a likelihood of accessing at least 3 advertisements per week presented via the application, and a likelihood of using the application at least 5 times per day.

Classifications associated with a user may be used to select content for presentation to the user. For example, targeting criteria associated with one or more advertisements are compared to classifications associated with a user, and advertisements associated with targeting criteria matching one or more classifications associated with the user are identified as advertisements eligible for presentation to the user. As a specific example, an advertiser associates targeting criteria identifying a classification of a threshold likelihood to make a purchase in a shopping application with an advertisement including a coupon code for purchases so the advertisement is presented to users associated with a classification of at least the threshold likelihood of making a purchase in the shopping application. In another example, users associated with a classification of being unlikely to make purchases via game applications but associated with a classification of being likely to spend at least 5 hours per week interacting with game applications are targeted to receive more advertisements than promotions for purchases that may be made while using game applications. In some embodiments, classifications associated with a user may indicate the user spends at least a threshold amount of money within an application and/or invites at least a threshold number of other users or entities to be associated with the application. The social networking system 140 may select advertisements for presentation to the user based on these classifications. For example, advertisements selected for presentation to users classified as spending at least the threshold amount of money or inviting at least the threshold number of users to associate with the application encourage the classified user to install a new application, to engage more with the current application (via e.g., promotions, in-game bonuses within the current application), or some combination thereof.

In some embodiments, if a classification associated with a user indicates the user spends at least a threshold amount of time interacting with an application, the social networking system 140 identifies advertisements for presentation via the application associated with targeting criteria specifying the threshold amount of time interacting with the application as eligible for presentation to the user. In some embodiments, the threshold amount of time may be an estimated time the user interacts with the application before leaving the application. Based on the threshold amount of time the user interacts with the application, advertisements selected for presentation to the user may identify an additional application that is similar to the application, additional bonus features of the application (e.g., discount for using the application, higher level in an in-application game, etc.) to encourage the user to stay engaged with the application and/or encourage the user to again engage with the application. The social networking system 140 may then provide one or more of the advertisements to the user client 110 before the threshold amount of time that the user interacts with the application elapses. Using classifications associated with a user based on the user's interactions with an application as targeting criteria for advertisements increases the likelihood of the user interacting with a presented advertisement.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
providing program code to one or more developers of one or more applications, the program code for inclusion in the one or more applications and for communication of information describing interactions of users of a social networking system with the one or more applications to the social networking system;
receiving, at the social networking system, the information from the provided program code included in one or more applications describing interactions of users of the social networking system with each of the one or more applications, the information identifying an application in which the provided program code was included, identifying one or more users who interacted with the application in which the program code was included, and describing one or more interactions of the one or more users with the application in which the program code was included;
storing the received information describing interactions of the one or more users with the one or more applications;
retrieving information describing interactions of a user of the social networking system with the one or more applications;
determining a likelihood of the user performing each of one or more types of interactions with a selected application based at least in part on the retrieved information describing the interactions of the user with the one or more applications; and
determining one or more classifications associated with the user based at least in part on the determined likelihoods.

2. The method of claim 1, further comprising:
selecting content for presentation to the user based at least in part on the one or more classifications associated with the user.

3. The method of claim 2, wherein selecting content for presentation to the user based at least in part on the one or more classifications associated with the user comprises:
selecting one or more advertisements associated with one or more targeting criteria satisfied by at least one classification associated with the user.

4. The method of claim 3, wherein a selected advertisement is presented via the selected application.

5. The method of claim 2, further comprising:
determining whether to present one or more promotions to the user via the selected application based at least in part on the one or more classifications associated with the user.

6. The method of claim 1, wherein determining likelihoods of the user performing one or more types of interactions with the selected application based at least in part on the retrieved information describing interactions of the user with the one or more applications comprises:
retrieving stored information describing interactions of the user with one or more additional applications each having at least a threshold measure of similarity with the selected application; and
determining the likelihoods of the user performing one or more types of interactions with the selected application based at least in part on the retrieved information describing interactions of the user with the one or more applications and on the stored information describing interactions of the user with the one or more additional applications each having at least the threshold measure of similarity with the selected application.

7. The method of claim 6, wherein determining likelihoods of the user performing one or more types of interactions with the selected application based at least in part on the retrieved information describing interactions of the user with the one or more applications comprises:
associating weights with interactions of the user with different additional applications having at least the threshold measure of similarity with the selected application, a weight associated with an additional application based at least in part on the measure of similarity between the selected application and the additional application; and
determining the likelihoods of the user performing one or more types of interactions with the selected application based at least in part on the retrieved information describing interactions of the user with the one or more applications, on the stored information describing interactions of the user with the one or more additional applications each having at least the threshold measure of similarity with the selected application, and on the weights.

8. The method of claim 1, wherein determining likelihoods of the user performing one or more types of interactions with the selected application based at least in part on the retrieved information describing interactions of the user with the one or more applications comprises:
retrieving information describing interactions of one or more additional users with at least a threshold measure of similarity with the user with the one or more applications if less than a threshold amount of information describing interactions of the user of the social networking system with the one or more applications was received; and;
determining the likelihoods of the user performing one or more types of interactions with the selected application based at least in part on the retrieved information describing interactions of the user with the one or more applications and on the retrieved information describing interactions of the one or more additional users with at least the threshold measure of similarity with the user and the one or more applications.

9. The method of claim 8, wherein determining likelihoods of the user performing one or more types of interactions with the selected application based at least in part on the retrieved information describing interactions of the user with the one or more applications comprises:
associating weights with interactions of each additional user, a weight associated with interactions of an additional user based at least in part on the measure of similarity between the additional user and the user; and
determining the likelihoods of the user performing one or more types of interactions with the selected application based at least in part on the retrieved information describing interactions of the user with the one or more applications, on the retrieved information describing interactions of the one or more additional users having at least the threshold measure of similarity with the user and the one or more applications, and on the weights.

10. The method of claim 1, wherein the one or more types of interactions with a selected application are selected from a group consisting of: an installation of the selected application, a purchase made via the selected application, an interaction with one or more advertisements presented via the selected application, a social interaction performed via the selected application, an amount of usage of the selected application, and any combination thereof.

11. A method comprising:
receiving, at a social networking system, information describing one or more interactions of one or more users of the social networking system with one or more applications, the information including information identifying each of the users, identifying one or more types of interactions performed, and identifying each of the one or more applications;
storing the received information describing the one or more interactions with the one or more applications in association with the one or more users;
determining likelihoods of a user from the one or more users performing one or more types of interactions with an application based at least in part on the received information describing interactions of the user with the one or more applications; and
determining one or more classifications associated with the user based at least in part on the likelihoods.

12. The method of claim 11, wherein the information describing the one or more interactions of the one or more users of the social networking system with the one or more applications is received from the one or more applications.

13. The method of claim 11, further comprising:
selecting content for presentation to the user based at least in part on the one or more classifications associated with the user.

14. The method of claim 13, wherein selecting content for presentation to the user based at least in part on the one or more classifications associated with the user comprises:
selecting one or more advertisements associated with one or more targeting criteria satisfied by at least one classification associated with the user.

15. The method of claim 14, wherein a selected advertisement is presented via the application.

16. The method of claim 1, wherein the one or more types of interactions with the application are selected from a group consisting of: an installation of the application, a purchase made via the application, an interaction with one or more advertisements presented via the application, a social interaction performed via the application, an amount of usage of the application, and any combination thereof.

17. The method of claim 11, wherein the application is not included in the one or more applications.

18. A computer program product comprising a computer readable storage medium having instructions encoded therein that, when executed by a processor, cause the processor to:
receive, at a social networking system, information describing one or more interactions of one or more users of the social networking system with one or more applications, the information including information identifying each of the users, identifying one or more types of interactions performed, and identifying each of the one or more applications;
store the received information describing the one or more interactions with the one or more applications in association with the one or more users;
determine likelihoods of a user from the one or more users performing one or more types of interactions with an application based at least in part on the received information describing interactions of the user with the one or more applications; and
determine one or more classifications associated with the user based at least in part on the likelihoods.

19. The computer program product of claim 18, wherein the computer-readable storage medium further has instructions encoded thereon that, when executed by the processor, cause the processor to:
select content for presentation to the user based at least in part on the one or more classifications associated with the user.

20. The computer program product of claim 19, wherein select content for presentation to the user based at least in part on the one or more classifications associated with the user comprises:
select one or more advertisements associated with one or more targeting criteria satisfied by at least one classification associated with the user.
